(19) United States
(12) Patent Application Publication
(10) Pub. No.: US 2009/0218539 A1
(43) Pub. Date: Sep. 3, 2009

(54) POLYMER-BONDED MAGNETIC MATERIALS

(76) Inventors: Ka Wai Cheng, Hong Kong (HK); Yuen Was Wong, Hong Kong (HK); Wei Tai Wu, Hong Kong (HK); Kai Ding, Hong Kong (HK); Yiu Lun Ho, Hong Kong (HK); Tsz Kong Cheung, Hong Kong (HK); Chi Keong Cheong, Hong Kong (HK)

Correspondence Address: EVAN LAW GROUP LLC, 600 WEST JACKSON BLVD., SUITE 625, CHICAGO, IL, 60661, US

(21) Appl. No.: 12/039,592

(22) Filed: Feb. 28, 2008

(51) Int. Cl. H01F 1/26

(52) U.S. Cl. 252/62.54

(57) ABSTRACT

A magnetic composition for power conversion includes a thermoplastic polymer and magnetic powders. The composition has a tensile strength of greater than 20 N/nm².

### BACKGROUND

The design of magnetic power converters depends on factors including the permeability, loss factor, and size and shape of the magnetic material in the converter. Specifically, the loss for magnetic material usually accounts for 30-40% of the total loss of the converter. Conventional magnetic materials, such as Ferrites and Molydbenum Permalloy Powder (MPP), are known for their low loss characteristics and high frequency operation. Therefore, these magnetic materials may be used in power converters, such as inductors and transformers. However, these magnetic materials suffer from a number of disadvantages, including limited size, brittleness, high loss and high cost.

For example, it is difficult to provide a transformer or inductor useful in high power conversion, such as a system of more than 20 kW, because of the complexity and expense in the formation of Ferrites or powder iron. In addition, conventional materials must be screened in this application. A metal and plastic material chassis is often used to screen electromagnetic emissions, which increases the cost and the weight of the electronic product.

The loss in power conversion can be divided into conductor loss and core loss. The conductor loss, or winding loss, is the resistive loss due to the current passed through the winding around the magnetic material. Because of the current distribution in the conductor at high frequency, this loss can increase dramatically as the frequency increases. The core loss is usually caused by the hysteresis, eddy loss and/or residue loss of the magnetic materials. The hysteresis loss and eddy loss can be decreased by using power iron core for high frequency application. The introduction of polymer into the conventional core could also lower the eddy loss to some extent, which could extend their applications to a broader range at high frequency area.

The technology and engineering domains constantly set demanding requirements of magnetic materials. Recently, polymer bonded magnetic materials have attracted a great deal of attention in the fields of magneto-electrics and magneto-optics. These materials are composed of polymer matrices and magnetic powders, which may be produced using traditional polymer processing methods. Polymer bonded magnetic materials offer significant advantages over conventional materials. For example, polymer bonded magnetic materials can be molded more easily, lowering the cost of manufacturing and of quality control. Nonetheless, the polymer-bonded magnetic materials have not typically been applicable in power conversion or electromagnetic interference. The outstanding work needed in the optimization and the permeability study has prevented developing the materials into a product.

It is desirable to produce a magnetic material that could be easier to form into device cores for application in high power conversion (over 20 kW). Ideally, these magnetic materials would have sufficient flexibility. It is also desirable to manufacture the magnetic material at a low cost. It is further desirable to produce a magnetic material that is light weight. It is also desirable to produce a magnetic material useful for high frequency power conversion, such as over 100s kHz operation. It is further desirable to that the magnetic material is applicable in power transformers and inductors.

### BRIEF SUMMARY

According to one aspect, a magnetic composition for power conversion includes a thermoplastic polymer and magnetic powders. The composition has a tensile strength of greater than 20 N/nm².

According to another aspect, a method of making a magnetic composition for power conversion includes mixing Fe₂O₃, NiO and ZnO into a mixture in a high-speed blender, crushing the mixture in a high-speed blender into magnetic powders, mixing dried PMMA pellets with Stearic acid (C₁₈H₃₆O₂) in a high-speed blender to form polymer powders with appropriate size, and mixing the magnetic powders and the polymer powders in a high-speed blender.

### BRIEF DESCRIPTION OF THE DRAWINGS

FIG. 1A depicts the ring cores based on 10 wt % PE−90 wt % FeNiZn(50:20:30 mol) (1300° C., 950 minutes).

FIG. 1B depicts the measurement results of FIG. 1A, with initial values: f=5 KHz, L=56.00 μH, μᵣ=42.17 and peak values: f=14.30 MHz, L=125.89 μH, μᵣ=94.80.

FIG. 2A depicts the ring cores based on 10 wt % PE−90 wt % FeNiZn(50:30:20 mol) (1300° C., 950 minutes).

FIG. 2B depicts the measurement results of FIG. 2A, with initial values: f=5 KHz, L=50.49 μH, μᵣ=38.02 and peak values: f=13.70 MHz, L=108.62 μH, μᵣ=81.79.

FIG. 3A depicts the ring cores based on 10 wt % PE−90 wt % FeNiZn(50:40:10 mol) (1300° C., 950 minutes).

FIG. 3B depicts the measurement results of FIG. 3A, with initial values: f=5 KHz, L=38.30 μH, μᵣ=28.94 and peak values: f=19.30 MHz, L=135.91 μH, μᵣ=102.34.

FIG. 4A depicts the ring cores based on 10 wt % PE−90 wt % FeNiZn(50:20:30 mol) (1100° C., 20 hours).

FIG. 4B depicts the measurement results of FIG. 4A, with initial values: f=5 KHz, L=43.98 μH, μᵣ=33.12 and peak values: f=20.2 MHz, L=120.15 μH, μᵣ=90.47.

FIG. 5 depicts the typical curves of load (N) vs. extension (mm) in tensile strength measurements.

FIG. 6 depicts the typical curves of load (N) vs. deflection (mm) in resistance to compression measurements.

FIG. 7 depicts the typical curves of load (N) vs. deflection (mm) in radial crushing strength measurements.

FIG. 8 depicts how external field may be applied to aid the alignment of a magnetic dipole by using a hot-press machine.

FIG. 9 depicts constructed embodiments of the polymer-bonded magnetic core.

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

A magnetic composition may include a thermoplastic polymer and magnetic powers. The composition has a tensile strength of greater than 20 N/nm². Formed magnetic cores including the magnetic composition may have better mechanical properties than conventional cores. For example, magnetic cores including the magnetic composition may have a tensile strength of greater than 20 N/mm², and may have a resistance to compression of greater than 40 N/mm². Magnetic cores including the magnetic composition may be used for power conversion applications, such as power transformers, power inductors, and ferrites screens.

Composition

A magnetic composition for power conversion may include a thermoplastic polymer and a magnetic powder. The thermoplastic polymer may be taken from the group consisting of poly(methyl methacrylate) (PMMA) and polyethylene (PE). Other polymers, such as Nylon 6, may also be used, which may vary the operational temperature of the products. The magnetic powder may be taken from the group consisting of Nickel, Cobalt, NiZn Ferrite, and MnZn Ferrite. Optionally, a coupling agent of Titanium (IV) Isopropoxide (C₁₂H₂₈O₄Ti) may be included in the composition. For example, the composition may contain from about 10 to 40 weight percent of the thermoplastic polymer, from about 60 to 90 weight percent of the magnetic powder, and the magnetic powder may contain about 15 weight percent of the coupling agent.

Methods

To produce the polymer-bonded magnetic material, appropriate amounts of Fe₂O₃, NiO and ZnO in different mole ratios (50:20:30, 50:30:20, or 50:40:10) may be vigorously mixed in a high-speed blender for about 2 minutes. The mixture may then be sintered in a high-temperature calcination furnace. The furnace may be heated at a rate of 8° C./min to 1300° C. and maintained at this temperature for 950 minutes. The melted mixture may be taken out immediately, which may then be placed at about 20° C., and allowed to cool down to room temperature rapidly. The cooled mixture may then be crushed in a high-speed blender to provide magnetic powders.

To remove most of the moisture in the mixture, PMMA pellets may be dried in an oven at about 60° C. for about 6 hours, and the magnetic powders may be also dried in an oven at about 60° C. for about 4 hours. To modify the surface properties of the magnetic powders, the dried magnetic powders may be vigorously mixed with Titanium (IV) Isopropoxide (C₁₂H₂₈O₄Ti) in a high-speed blender. The dried magnetic powders may contain about 15 weight percent of C₁₂H₂₈O₄Ti. Then, the mixture may be dried in an oven at about 60° C. for about 3 hours. Such a modification may improve the compatibility between the magnetic powders and the polymer, which in turn may improve the properties of the composite.

The dried PMMA pellets may be mixed with Stearic acid (C₁₈H₃₆O₂) in a high-speed blender to form polymer powders with appropriate size. The dried PMMA may contain about 2 weight percent of C₁₈H₃₆O₂. The modified magnetic powders and polymers may then be vigorously premixed in a high-speed blender. This mixture may be blended further using a single-screw extruder operating at an appropriate rotation speed. The temperature setting may be selected as: Zone 1 at 210° C., Zone 2 at 230° C., Zone 3 at 265° C., and Zone 4 at 260° C. The extrusion may become difficult at lower temperatures, while higher temperatures may cause inconsistency in properties. The mixture may then be placed in a predefined mould and made into a magnetic core in a hot press machine operated at above 150° C. at 6 to 10 ton press, which is above the melting point of the polymer to be used in the magnetic core.

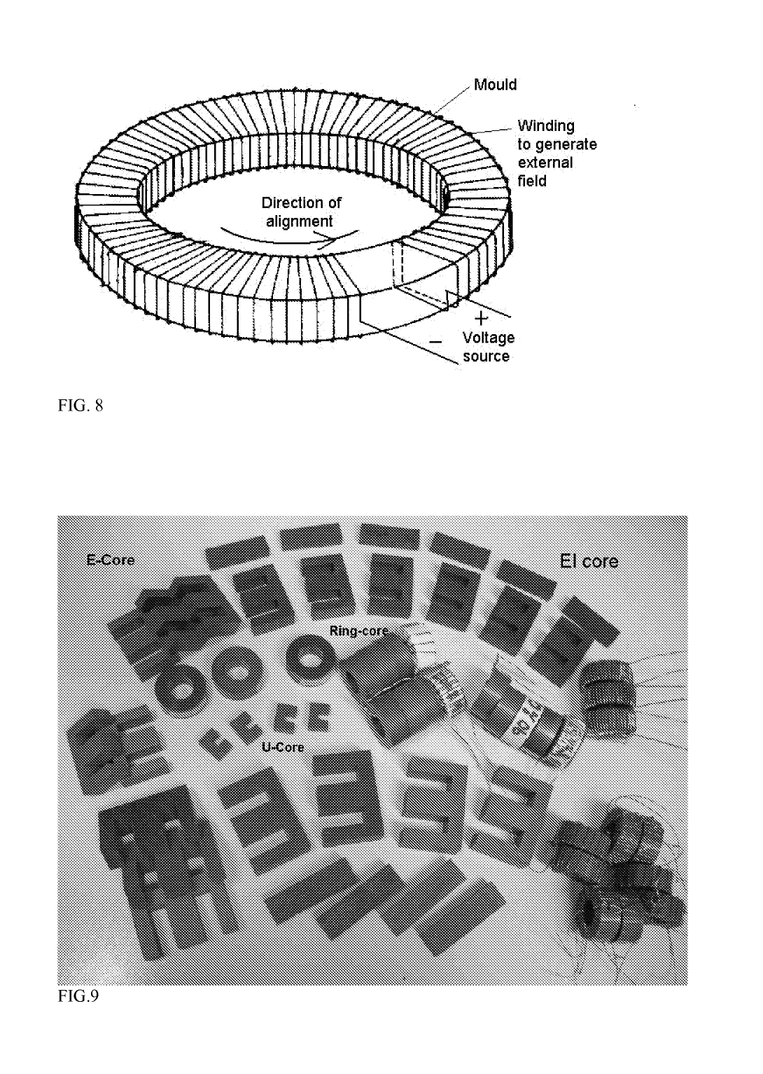

To increase the permeability of the magnetic cores, an external magnetic field may be applied to aid the alignment of the magnetic dipole inside the magnetic materials. The external magnetic field may be supplied from a permanent magnetic or an electric-winding. The magnetic filed applied may be in the same direction as the main field direction of the core under construction as depicted in FIG. 8.

While not being bound by theory, it is believed that an evenly distributed air-gap in the magnetic composition may reduce the fringe field and/or reduce the eddy current loss, which is desirable for high frequency power electronics.

Products

Magnetic cores based on the polymer-bonded magnetic materials may be fabricated on a hot-press machine operated at 180° C. and at about 6 to 10 tons, with a mould of desired shape. Magnetic cores fabricated using the magnetic composition may have various shapes, such as a ring, an EE, an EI, and a U shape, as depicted in FIG. 9. An EE-shape refers to when the shape of the magnetic core is in the geometry of two letter Es. An EI-shape refers to when the shape of the magnetic core is in the geometry of a letter E and a letter I. A U-shape refers to when the shape of the magnetic core is in the geometry of a letter U. A ring-shape refers to the shape of the magnetic core is similar to a circular ring. Other shapes, such as irregular geometry, may also be used.

A formed magnetic core includes the magnetic composition may have better mechanical properties than the conventional magnetic cores. For example, the magnetic cores may have a tensile strength of greater than 20 N/mm² and a resistance to compression of greater than 40 N/mm².

Magnetic cores including the magnetic composition may be used, for example, as power transformers, power inductors, and ferrites screens.

### EXAMPLES

### Example 1

### The Magnetic Properties of the Composition

The magnetic properties measurements were carried out on a ring core (Ø30×Ø15×H₁₂ mm). Inductance (L) was measured on a HIOKI 3530 LCR Hi Tester, and then the relative permeability μᵣ was calculated. From the equivalent circuit of the ring core shown above, the impedance Z should be Z=Rₛ+jωLₛ.

And Z=jωL₀ (μ′−jμ″). Herein, μ′ and μ″ is the real part and the imaginary part of the magnetic permeability, respectively. ω is the rotational frequency. Then,

$${R}_{s} + jω {L}_{s} = jω {L}_{0} ( {μ}^{′} - {jμ}^{″} )$$

$$Quality factor : Q = \frac{ω L}{R} , \\ thus {μ}^{′} = \frac{{L}_{s}}{{L}_{0}} , {μ}^{″} = \frac{{μ}^{′}}{Q}$$

Also, the inductance value Lₒ of the air

$${L}_{0} = \frac{4 π {N}^{2} {A}_{e}}{{l}_{e}} \times {10}^{- 9} , \frac{{A}_{e}}{{l}_{e}} = 2 π h ln ( \frac{{r}_{2}}{{r}_{1}} )$$

Herein, N is the loop number. Ae is the effective area of the flux. le is the effective length of the magnetic circuit. r₁ is the inside diameter, r₂ is the inside diameter, and h is the highness of the ring core.

Finally,

$${μ}^{′} = \frac{{L}_{s} \times {10}^{9}}{8 {π}^{2} {N}^{2} h ln ( \frac{{r}_{2}}{{r}_{1}} )}$$

$$μ = \frac{{L}_{s} \times {10}^{9}}{8 {π}^{2} {N}^{2} h ln ( \frac{{r}_{2}}{{r}_{1}} )} \cdot \sqrt{1 + 1 / {Q}^{2}}$$

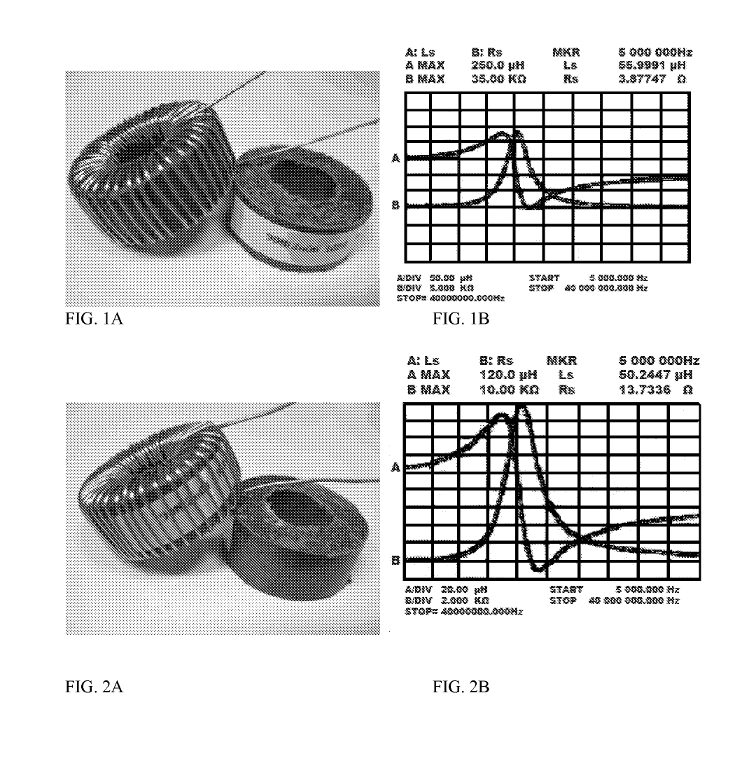

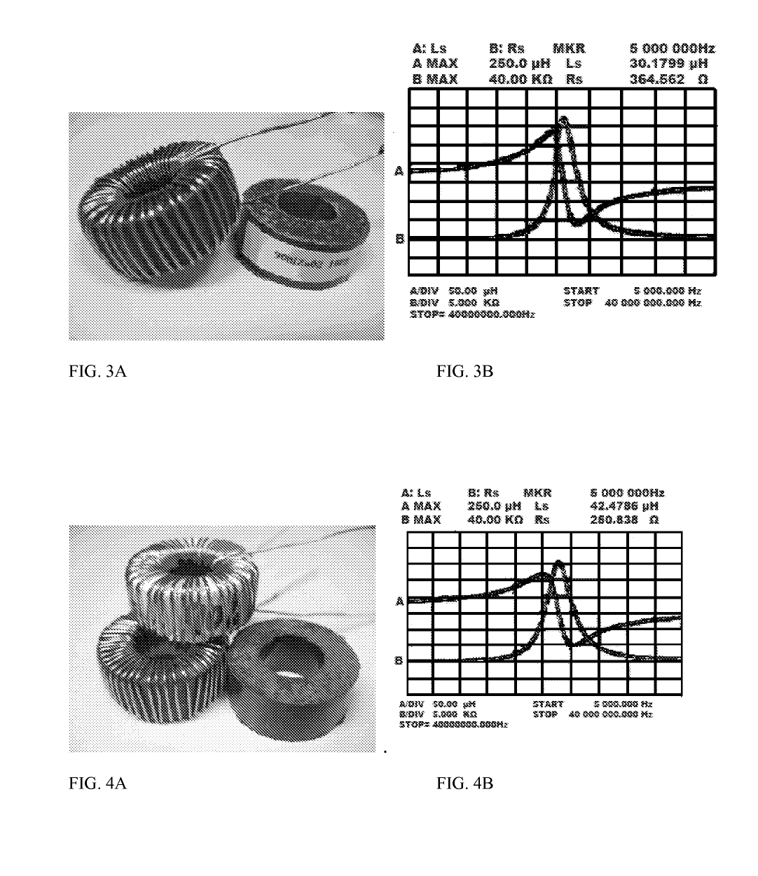

Typical images are shown in FIGS. 1 to 4, wherein Loop Number N=45, μᵣ≈0.753×Lₛ(μH). The results for the above results and those for other objects are concluded in Table 1 and Table 2.

TABLE 1
The inductance and relative permeability of the composition

| Samples' | | | | | | | | |
|---|---|---|---|---|---|---|---|---|
| Composition | | 5 KHz | 50 KHz | 100 KHz | 500 KHz | 1 MHz | 2 MHz | 10 MHz |
| 10 wt % PE | L | 43.98 | 42.55 | 42.40 | 42.03 | 41.98 | 42.29 | 55.54 |
| 90 wt % | (μH) | | | | | | | |
| FeNiZn(50:20:30 mol) | μᵣ | 33.12 | 32.04 | 31.93 | 31.65 | 31.61 | 31.84 | 41.82 |
| (1100° C., 950 | | | | | | | | |
| minutes) | | | | | | | | |
| 10 wt % PE, | L | 42.40 | 41.45 | 41.29 | 40.91 | 40.86 | 41.03 | 50.91 |
| 10% PMMA | (μH) | | | | | | | |
| 80 wt % | μᵣ | 31.93 | 31.21 | 31.09 | 30.80 | 30.77 | 30.90 | 38.34 |
| FeNiZn(50:20:30 mol) | | | | | | | | |
| (1100° C., 950 | | | | | | | | |
| minutes) | | | | | | | | |
| 30 wt % PE | L | 16.40 | 16.00 | 15.91 | 15.73 | 15.70 | 15.70 | 16.84 |
| 70 wt % | (μH) | | | | | | | |
| FeNiZn(50:20:30 mol) | μᵣ | 12.35 | 12.05 | 11.98 | 11.84 | 11.82 | 11.82 | 12.68 |
| (1100° C., 950 | | | | | | | | |
| minutes) | | | | | | | | |
| 40 wt % | L | 13.65 | 9.95 | 9.84 | 9.69 | 9.65 | 9.64 | 10.03 |
| PMMA | (μH) | | | | | | | |
| 60 wt % | μᵣ | 10.28 | 7.49 | 7.41 | 7.30 | 7.27 | 7.26 | 7.55 |
| FeNiZn(50:20:30 mol) | | | | | | | | |
| (1100° C., 950 | | | | | | | | |
| minutes) | | | | | | | | |
| 10 wt % PE | L | 56.00 | 55.45 | 55.26 | 54.86 | 55.01 | 55.59 | 80.58 |
| 90 wt % | (μH) | | | | | | | |
| FeNiZn(50:20:30 mol) | μᵣ | 42.17 | 41.75 | 41.61 | 41.31 | 41.42 | 41.86 | 60.68 |
| (1300° C., 950 | | | | | | | | |
| minutes) | | | | | | | | |
| 10 wt % PE | L | 50.49 | 49.38 | 49.27 | 48.98 | 49.06 | 49.77 | 77.51 |
| 90 wt % | (μH) | | | | | | | |
| FeNiZn(50:30:20 mol) | μᵣ | 38.02 | 37.18 | 37.10 | 36.88 | 31.19 | 37.48 | 58.37 |
| (1300° C., 950 | | | | | | | | |
| minutes) | | | | | | | | |
| 10 wt % PE | L | 38.30 | 37.94 | 37.84 | 37.53 | 37.47 | 37.61 | 48.86 |
| 90 wt % | (μH) | | | | | | | |
| FeNiZn(50:40:10 mol) | μᵣ | 28.94 | 28.57 | 28.49 | 28.26 | 28.21 | 28.32 | 36.79 |
| (1300° C., 950 | | | | | | | | |
| minutes) | | | | | | | | |
| 80 wt % Co | L | 13.50 | 12.47 | 12.30 | 11.17 | 9.36 | 7.10 | — |
| 20 wt % | (μH) | | | | | | | |
| PMMA | μᵣ | 10.17 | 9.39 | 9.26 | 8.41 | 7.05 | 5.35 | — |
| 90 wt % Co | L | 14.00 | 12.39 | 12.28 | 11.88 | 11.12 | 9.41 | — |
| 10 wt % | (μH) | | | | | | | |
| PMMA | μᵣ | 10.54 | 9.33 | 9.25 | 8.95 | 8.37 | 7.09 | — |

TABLE 2
The inductance and relative permeability of the composition

| | | 5 | 10 | 25 | 50 | 75 | 100 |
|---|---|---|---|---|---|---|---|
| Samples' Composition | | KHz | KHz | KHz | KHz | KHz | KHz |
| 60 wt % Co-40 wt % | L | — | — | 1.34 | 1.32 | 1.32 | 1.32 |
| PMMA | (μH) | | | | | | |
| | μᵣ | — | — | 16.89 | 16.63 | 16.63 | 16.63 |
| 70 wt % Co-30 wt % | L | 1.26 | 1.23 | 1.20 | 1.20 | 1.20 | 1.19 |
| PMMA | (μH) | | | | | | |
| | μᵣ | 15.88 | 15.50 | 15.12 | 15.12 | 15.12 | 14.99 |
| 60 wt % Ni-40 wt % | L | — | — | 1.34 | 1.32 | 1.32 | 1.32 |
| PMMA | (μH) | | | | | | |
| | μᵣ | — | — | 16.88 | 16.63 | 16.63 | 16.63 |
| 70 wt % Ni-30 wt % | L | 1.12 | 1.07 | 1.03 | 1.02 | 1.01 | 1.01 |
| PMMA | (μH) | | | | | | |
| | μᵣ | 14.11 | 13.48 | 12.98 | 12.85 | 12.73 | 12.73 |

### Example 2

### The Tensile Strength of the Composition

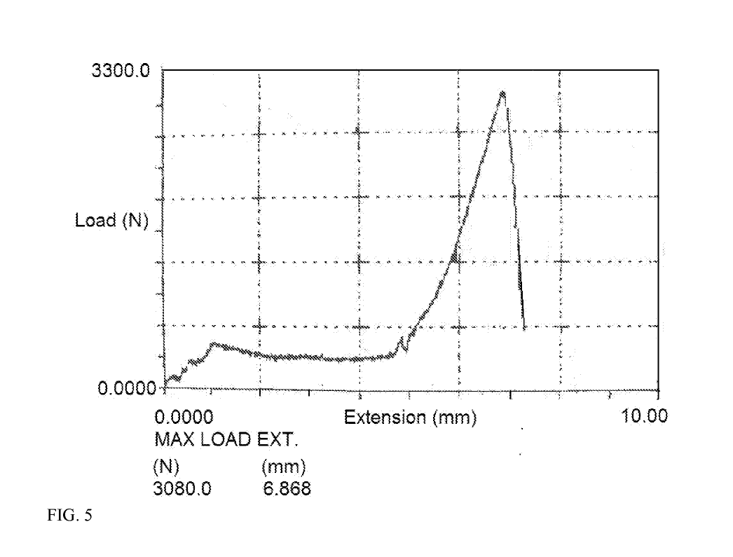

The tensile strength measurement was carried out on a Lloyd Instruments LR30KPLUS Series Universal Material Tester. FIG. 5 shows the typical curves of load (N) vs. extension (mm). The measurement results are listed in Table 3.

TABLE 3
The tensile strength of the composition

| | Tensile | | Tensile |
|---|---|---|---|
| | Strength | | Strength |
| Sample's Composition | (N/mm²) | Sample's Composition | (N/mm²) |
| 60 wt % | 20.15 | 60 wt % | 29.56 |
| FeNiZn(50:20:30 | | FeNiZn(50:20:30 mol) - | |
| mol) - 40 wt % | | 40 wt % PE | |
| PMMA | | | |
| 70 wt % | 22.35 | 70 wt % | 45.21 |
| FeNiZn(50:20:30 | | FeNiZn(50:20:30 mol) - | |
| mol) - 30 wt % | | 30 wt % PE | |
| PMMA | | | |
| | | 80 wt % | 60.17 |
| | | FeNiZn(50:20:30 mol) - | |
| | | 20 wt % PE | |
| | | 90 wt % | 89.28 |
| | | FeNiZn(50:20:30 mol) - | |
| | | 10 wt % PE | |

### Example 3

### The Resistance to Compression of the Composition

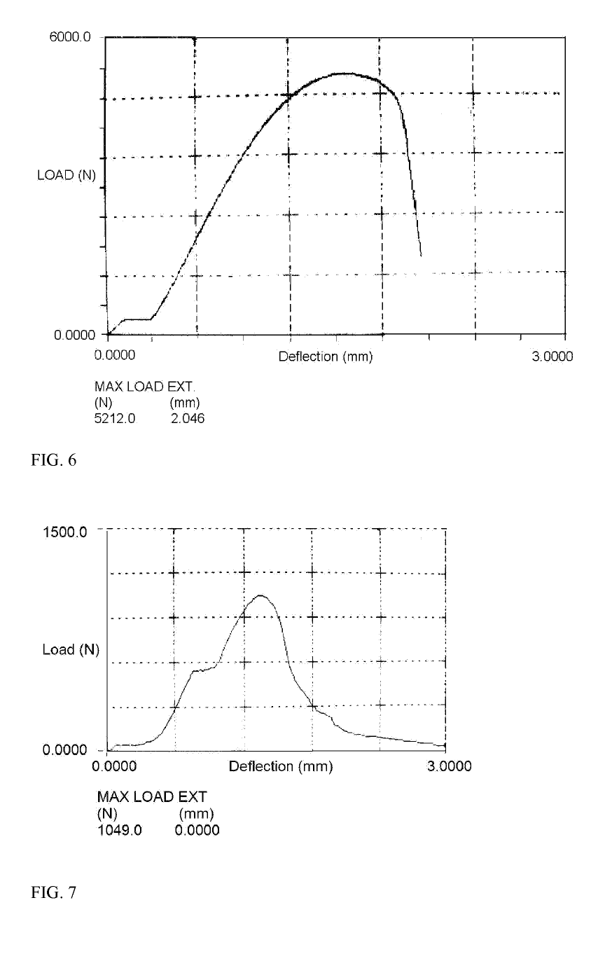

The resistance to compression measurement was carried out on the rectangular samples on a Lloyd Instruments LR30 KPLUS Series Universal Material Tester. FIG. 6 shows the typical curves of load (N) vs. deflection (mm). The measurement results are concluded in Table 4.

TABLE 4
The resistance to compression of the composition

| | Resistance to | | Resistance to |
|---|---|---|---|
| Sample's | Compression | | Compression |
| Composition | (N/mm²) | Sample's Composition | (N/mm²) |
| 60 wt % | 57.91 | 60 wt % | 39.82 |
| FeNiZn(50:20:30 | | FeNiZn(50:20:30 | |
| mol) - 40 wt % | | mol) - 40 wt % PE | |
| PMMA | | | |
| 70 wt % | 58.24 | 70 wt % | 42.66 |
| FeNiZn(50:20:30 | | FeNiZn(50:20:30 | |
| mol) - 30 wt % | | mol) - 30 wt % PE | |
| PMMA | | | |
| | | 80 wt % | 45.20 |
| | | FeNiZn(50:20:30 | |
| | | mol) - 20 wt % PE | |
| | | 90 wt % | 44.01 |
| | | FeNiZn(50:20:30 | |
| | | mol) - 10 wt % PE | |

### Example 4

### The Radial Crushing Strength of the Composition

The radial crushing strength measurement was carried out on the ring core, and was calculated based on the following formula:

$${σ}_{r} = \frac{1.908 {P}_{r} ( D - t )}{2 {Lt}^{2}}$$

Herein, Pr is the maximal load (N), D is the outer diameter, t is the thickness, and L is the width of the sample. The measurement results are concluded in Table 5.

TABLE 5
The radial crushing strength of the composition

| | Radial | | Radial |
|---|---|---|---|
| | Crushing | | Crushing |
| Sample's | Strength | | Strength |
| Composition | (N/mm²) | Sample's Composition | (N/mm²) |
| 60 wt % | 207.57 | 60% NiZn - 40% PE | 51.11 |
| FeNiZn(50:20:30 mol) | | | |
| 40 wt % PMMA | | | |
| 70 wt % | 342.36 | 70% NiZn - 30% PE | 75.02 |
| FeNiZn(50:20:30 mol) | | | |
| 30 wt % PMMA | | | |
| | | 80% NiZn - 20% PE | 72.56 |
| | | 90% NiZn - 10% PE | 29.29 |
| | | 90% NiZn - 10% | 83.40 |
| | | UHMWPE 300 | |
| | | (UHMW = Ultra-High | |
| | | Molecular Weight) | |
| | | 90% NiZn - 10% | 102.13 |
| | | UHMWPE 500 | |

### Example 5

### The Impact Resistance of The Composition

Impact resistance of the sample was measured on a ZWICK MS25B&C D-7900 Impact Resistance Tester. The measurements were carried out on cuboid samples (50×14×9 mm) with an incision of “V” shape. The impact resistance AKV equals to the impact value AK obtained. The measurement results are concluded in Table 6.

TABLE 6
The impact resistance of the composition

| | Impact Resistance, |
|---|---|
| Samples' Composition | A_{KV} (J) |
| 60 wt % FeNiZn(50:20:30 mol) - 40 wt % | 0.25 J |
| PMMA | |
| 70 wt % FeNiZn(50:20:30 mol) - 30 wt % | 0.94 J |
| PE | |
| 90 wt % FeNiZn(50:20:30 mol) - 10 wt % | 0.43 J |
| PE | |

### Example 6

### The Rockwell Hardness of the Composition

Rockwell hardness was measured on an ESE WAY RB Hardness Tester. The measurements were carried out on cuboid samples (50×14×9 mm). The measurement results are concluded in Table 7.

TABLE 7
The Rockwell hardness of the composition

| | Rockwell Hardness Number, HR | | | | | |
|---|---|---|---|---|---|---|
| | Rockwell | | | | | |
| | Superficial | | Rockwell | | Rockwell | |
| | 30-T | | Standard F | | Standard B | |
| | 30 kg, 1/16 In | | 60 kg, 1/16 In | | 100 kg, 1/16 In | |
| Samples' Composition | ball | | ball | | ball | |
| 60 wt % | 94 | 94 | 119 | 121 | — | — |
| FeNiZn(50:20:30 mol) | | | | | | |
| 40 wt % PMMA | | | | | | |
| 70 wt % | 66 | 62 | — | — | — | — |
| FeNiZn(50:20:30 mol) | | | | | | |
| 30 wt % PE | | | | | | |
| 90 wt % | — | — | 94 | 94 | 78 | 79 |
| FeNiZn(50:20:30 mol) | | | | | | |
| 10 wt % PE | | | | | | |

While the examples of the magnetic composition have been described, it should be understood that the composition not so limited and modifications may be made. The scope of the composition is defined by the appended claims, and all devices that come within the meaning of the claims, either literally or by equivalence, are intended to be embraced therein.

### REFERENCES

K. W. E. Cheng and P. D. Evans, ‘Parallel-mode extended-period quasi-resonant convertor’, IEE Proceedings-B, Vol. 138, No. 5, September 1991, pp. 243-251.
D. H. Park, J. H. Shim, B. H. Kim, K. Y. Bae, K. Kim, and J. Joo, “Hybrid double wall nanotube of conducting polymer and magnetic nickel”, Mol. Cryst. Liq. Cryst. Vol. 445, pp. 101-106, 2006.
D. C. Jiles, “Recent advances and future directions in magnetic materials”, Acta Mater., Vol. 51, pp. 5907-5939, 2003.
H. W. Ott, “Noise reduction techniques in electronic systems”, New York: Wiley, 1987. X. Cao, Y. Luo and L. Feng, “Synthesis and properties of magnets/polyethylene composities”, Journal of Applied Polmer Science, Vol. 74(14), December 1999, pp. 3412-3416.
L. Wang, L. X. Feng, T. Xie, X. F. Qing, “New route for preparing magnetic polyolefins with well dispersed nanometer magnetic particles in polymer matrix using supported Fe3O4/AlR3/TiCl4 nanometer magnetic Ziegler-Natta catalyst”, Journal of Materials Science Letters, Vol. 18(18), September 1999, pp. 1489-1491.
K. W. E. Cheng, “Computation of the AC resistance of multistranded conductor inductors with multilayers for high frequency switching converters”, IEEE Transactions on Magnetics, Vol. 36, No. 4, July 2000, pp. 831-834.
W.-T. Wu, Y. W. Wong, and K. W. Eric Cheng, “Temperature dependence of magnetic properties of a polymer bonded magnetic material”, 2006 2nd International Conference on Power Electronics Systems and Applications, November 2006, pp. 73-76.
K. Ding, K. W. Eric Cheng, W.-T. Wu, and D. H. Wang, “Research on polymer-bonded magnetic materials for a buck converter”, 2006 2nd International Conference on Power Electronics Systems and Applications, November 2006, pp. 87-90.

What is claimed is:

1. A magnetic composition, comprising:
a thermoplastic polymer; and
magnetic powders,
wherein said composition has a tensile strength of greater than 20 N/nm².

2. The composition of claim 1, wherein said thermoplastic polymer is selected from the group consisting of poly(methyl methacrylate) resins, polyethylene resins, and mixtures thereof.

3. The composition of claim 2, wherein said thermoplastic polymer accounts for 10 to 40 weight percent of said composition.

4. The composition of claim 1, wherein said magnetic powders are selected from the group consisting of nickel, cobalt, nickel zinc ferrite, manganese zinc ferrite, and mixtures thereof.

5. The composition of claim 4, wherein said magnetic powders account for 60 to 90 weight percent of said composition

6. The composition of claim 1, wherein the magnetic powders further comprising a coupling agent.

7. The composition of claim 6, wherein said coupling agent is Titanium (IV) Isopropoxide.

8. The composition of claim 6, wherein the magnetic powders comprise 15 weight percent of said coupling agent.

9. The composition of claim 1, wherein the composition has a resistance to compression of greater than 40 N/nm².

10. The composition of claim 1, wherein the composition has a radical crushing strength of greater than 30 N/nm².

11. The composition of claim 1, wherein the composition has an impact resistance of greater than 0.25 J.

12. The composition of claim 1, wherein the composition has a Rockwell hardness of greater than 60.

13. A device, comprising a magnetic code made of said magnetic composition of claim 1, wherein said magnetic device is selected from the group consisting of power ferrites, a power transformer, and a power inducer.

14. A method of making a magnetic composition for power conversion, comprising:
mixing Fe₂O₃, NiO and ZnO into a mixture in a high-speed blender;
crushing said mixture in a high-speed blender into magnetic powders;
mixing dried PMMA pellets with Stearic acid (C₁₈H₃₆O₂) in a high-speed blender to form polymer powders with appropriate size; and
mixing said magnetic powders and said polymer powders in a high-speed blender.

15. The method of claim 14, further comprising sintering said mixture in a high-temperature calcination furnace, and cooling said mixture to room temperature prior to crushing said mixture.

16. The method of claim 15, wherein said furnace is heated at a rate of 8° C./min to 1300° C. and maintained at this temperature for 950 minutes.

17. The method of claim 14, further comprising drying said PMMA pellets in an oven at about 60° C. for about 6 hours prior to mixing with said magnetic powders.

18. The method of claim 14, further comprising drying said magnetic powders in an oven at about 60° C. for about 4 hours after crushing said mixture.

19. The method of claim 18, further comprising mixing said dried magnetic powders with Titanium (IV) Isopropoxide (C₁₂H₂₈O₄Ti) in a high-speed blender.

20. The method of claim 19, wherein the mass ratio of C₁₂H₂₈O₄Ti to said dried magnetic powders is about 15 weight percent.

21. The method of claim 19, wherein the mass ratio of C₁₈H₃₆O₂ to said dried PMMA is about 2 weight percent.

22. The method of claim 14, further comprising applying an external filed to aid the alignment of a material dipole to increase magnetic permeability.

23. The method of claim 22, wherein said external field is applied in the same direction of a flux direction in a magnetic core.
